(19) United States
(12) Patent Application Publication
(10) Pub. No.: US 2024/0255724 A1
(43) Pub. Date: Aug. 1, 2024

(54) OPTICAL APPARATUS

(71) Applicant: FURUKAWA ELECTRIC CO., LTD., Tokyo (JP)

(72) Inventors: Atsushi IZAWA, Tokyo (JP); Kazuya NAGASHIMA, Tokyo (JP); Atsushi KAJI, Tokyo (JP); Yozo ISHIKAWA, Tokyo (JP)

(73) Assignee: FURUKAWA ELECTRIC CO., LTD., Tokyo (JP)

(21) Appl. No.: 18/631,138

(22) Filed: Apr. 10, 2024

Related U.S. Application Data
(63) Continuation of application No. PCT/JP2022/037348, filed on Oct. 5, 2022.

(30) Foreign Application Priority Data
Oct. 11, 2021 (JP) 2021-166928

(51) Int. Cl. G02B 7/02

(52) U.S. Cl. CPC G02B 7/025

(57) ABSTRACT

An optical apparatus includes: a housing including a first member constituting at least a part of the housing; an optical component accommodated in the housing and configured to transmit or reflect light; and a second member fixed to the first member and including at least one opening configured to accommodate a part of the optical component, the second member being configured to support the optical component via an adhesive agent.

This application is a continuation of International Application No. PCT/JP2022/037348, filed on Oct. 5, 2022 which claims the benefit of priority of the prior Japanese Patent Application No. 2021-166928, filed on Oct. 11, 2021, the entire contents of which are incorporated herein by reference.

### BACKGROUND

The present disclosure relates to an optical apparatus.

In the related art, an optical apparatus in which an optical component that is accommodated in a housing is mounted on a bottom wall of the housing, a substrate, or the like via an adhesive agent is known (for example, Japanese Laid-open Patent Publication No. 2004-020740).

### SUMMARY

In the known optical apparatus, in some cases, inconvenience related to an adhesive agent may occur; for example, a degree of freedom of layout of components may be reduced to prevent components, such as optical components, from becoming obstacles in a process of applying or curing the adhesive agent or expected optical properties are not obtained because an optical component falls down due to thermal curing of the adhesive agent.

There is a need for an optical apparatus that includes an improved and novel component that may easily reduce inconvenience related to an adhesive agent for attaching an optical component to a member in a housing.

According to one aspect of the present disclosure, there is provided an optical apparatus including: a housing including a first member constituting at least a part of the housing; an optical component accommodated in the housing and configured to transmit or reflect light; and a second member fixed to the first member and including at least one opening configured to accommodate a part of the optical component, the second member being configured to support the optical component via an adhesive agent.

According to another aspect of the present disclosure, there is provided an optical apparatus including: a housing including a first member constituting at least a part of the housing; an optical component accommodated in the housing and configured to transmit or reflect light; and a second member fixed to the first member and configured to support the optical component, the second member including a first surface and a second surface that is located on an opposite side of the first surface, wherein the optical component includes a first optical system including a first optical element arranged on an opposite side of the second surface with respect to the first surface, and a second optical system including a second optical element arranged on an opposite side of the first surface with respect to the second surface.

### BRIEF DESCRIPTION OF THE DRAWINGS

FIG. 1 is an exemplary schematic plan view of an internal configuration of an optical apparatus of a first embodiment;

FIG. 2 is a cross-sectional view cut along II-II in FIG. 1;

FIG. 3 is an exemplary schematic partial cross-sectional view of an optical apparatus of a second embodiment;

FIG. 4 is an exemplary schematic partial cross-sectional view of an optical apparatus of a third embodiment;

FIG. 5 is an exemplary schematic partial cross-sectional view of an optical apparatus of a fourth embodiment;

FIG. 6 is an exemplary schematic partial cross-sectional view of an optical apparatus of a fifth embodiment;

FIG. 7 is an exemplary schematic partial cross-sectional view of an optical apparatus of a sixth embodiment;

FIG. 8 is an exemplary schematic partial cross-sectional view of an optical apparatus of a seventh embodiment;

FIG. 9 is an exemplary schematic partial cross-sectional view of an optical apparatus of an eighth embodiment; and

FIG. 10 is an exemplary schematic partial cross-sectional view of an optical apparatus of a ninth embodiment.

### DETAILED DESCRIPTION

Exemplary embodiments will be disclosed below. Configurations of embodiments described below, and operation and results (effects) achieved by the configurations are mere examples. The present disclosure may be realized by configurations other than those disclosed in the embodiments below.

A plurality of embodiments described below include the same components. Therefore, according to the components of each of the embodiments, it is possible to achieve the same operation and effects based on the same components. Further, in the following, the same components are denoted by the same reference symbols, and repeated explanation will be omitted in some cases.

In the present specification, the ordinal numbers are assigned for the sake of convenience in order to distinguish members, parts, directions, and the like, and do not indicate priorities or order.

Furthermore, in each of the drawings, an X direction is indicated by an arrow X, a Y direction is indicated by an arrow Y, and a Z direction is indicated by an arrow Z. The X direction, the Y direction, and the Z direction cross one another and are perpendicular to one another.

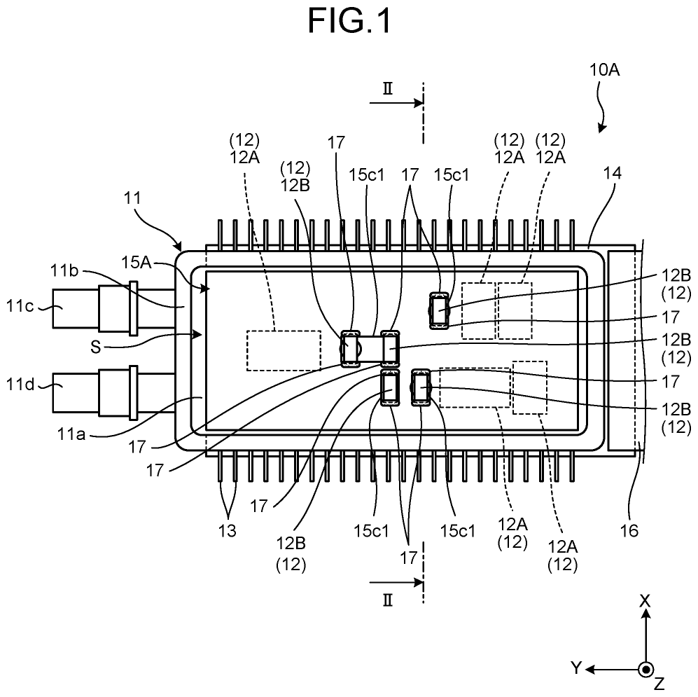

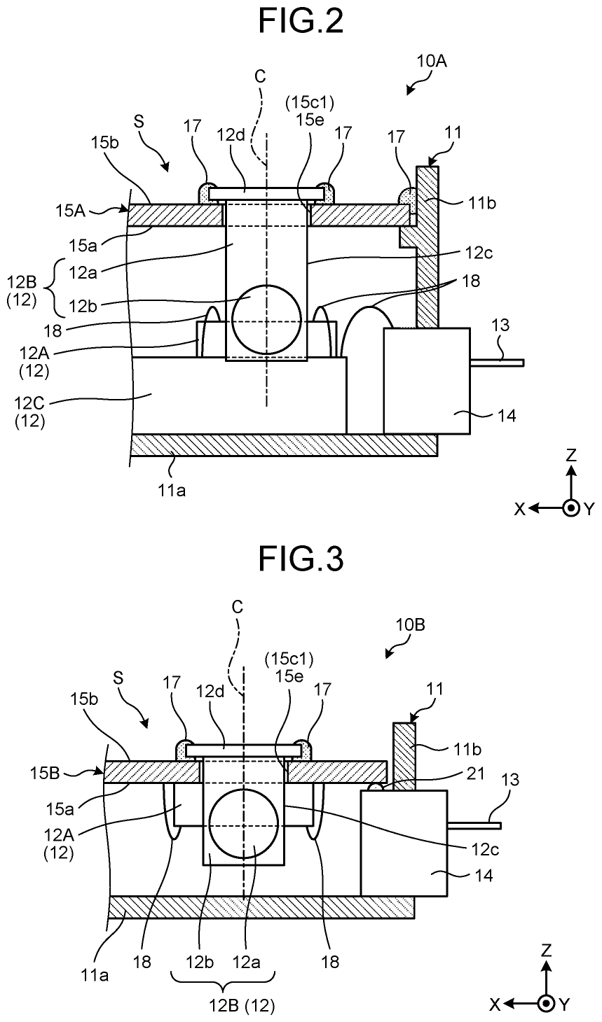

FIG. 1 is a plan view of an internal configuration of an optical apparatus 10A of a first embodiment. FIG. 1 is a diagram of the optical apparatus 10A viewed in an opposite direction of the Z direction in a state in which a flat-plate cover (not illustrated) that is located in an end portion of a housing 11 of the optical apparatus 10A in the Z direction is removed. Further, FIG. 2 is a cross-sectional view cut along II-II in FIG. 1.

As illustrated in FIG. 1, the optical apparatus 10A includes the housing 11, a plurality of parts 12 (12A, 12B, and 12C), a plurality of external connection pins 13, a feedthrough 14, and a support member 15A.

The housing 11 includes a bottom wall 11a, a peripheral wall 11b, ports 11c and 11d, and a cover (not illustrated). The bottom wall 11a has an approximately rectangular and plate-like shape. The bottom wall 11a crosses the Z direction and extends in the X direction and the Y direction. The peripheral wall 11b extends in the Z direction with approximately the same thickness from a rim of the bottom wall 11a. The peripheral wall 11b may also be referred to as a side wall.

The cover of the housing 11 has an approximately rectangular and plate-like shape, similarly to the bottom wall 11a. A periphery of the cover overlaps, in the Z direction, with an end edge of the peripheral wall 11b in the Z direction. The periphery of the cover and the end edge of the peripheral wall 11b in the Z direction are bonded together, so that a storage room S for storing the parts 12, the support member 15A, and the like is formed in the housing 11. The storage room S is hermetically sealed. Meanwhile, the storage room S may be filled with inert gas, such as nitrogen gas, for example.

The bottom wall 11a may be made of a material with high thermal conductivity, such as copper tungsten (CuW), copper molybdenum (CuMo), or aluminum oxide (Al₂O₃), for example. Further, the peripheral wall 11b and the cover may be made of a material with a low thermal expansion coefficient, such as a Fe—Ni—Co alloy or aluminum oxide (Al₂O₃), for example.

The ports 11c and 11d have cylindrical shapes and protrude laterally from a part of the peripheral wall 11b, that is, in the Y direction in the example in FIG. 1. One of the ports 11c and 11d serves as an input port, and the other one of the ports 11c and 11d serves as an output port. An input optical fiber (not illustrated) penetrates through the input port, and an output optical fiber (not illustrated) penetrates through the output port. A space between the ports 11c, 11d and the peripheral wall 11b and a space between the ports 11c, 11d and the optical fibers are hermetically sealed.

The parts 12 are stored in the storage room S, that is, in the housing 11. The parts 12 include the optical devices 12A, the optical components 12B, and the cooling mechanism 12C.

As illustrated in FIG. 2, in the present embodiment, as one example, the optical device 12A is mounted on the cooling mechanism 12C that is arranged on the bottom wall 11a. The cooling mechanism 12C is, for example, a thermoelectric cooler (TEC) that operates by being energized from outside of the housing 11 and is one example of an electrical component. Meanwhile, the optical device 12A may be mounted on the bottom wall 11a or a different member (not illustrated) that is fixed to the housing 11 and that is different from the cooling mechanism 12C.

The optical device 12A is energized from outside of the housing 11, that is, receives supply of electric power from outside of the housing 11, and performs at least one of output of light (transmission of light), reception of light (detection), and a change of a property, such as light intensity, a wavelength, a modulation frequency, a polarization state, or an interference state. Further, the optical device 12A is an optical component that electrically operates. Examples of the optical device 12A as described above include a chip on submount (light emitting unit), a wavelength locker that is a wavelength detector, a photodiode that is a photodetector, a photodiode array, a modulator, a modulator driver, a coherent mixer, and a transimpedance amplifier. Meanwhile, the optical device 12A is one example of an electrical component that electrically operates.

Furthermore, the optical component 12B transmits or reflect light, such as laser light. Examples of the optical component 12B as described above include a lens, a mirror, a beam combiner, a beam splitter, and an optical isolator.

The external connection pins 13 are attached to the housing 11 or the feedthrough 14. The plurality of external connection pins 13 extend in the X direction and are arranged at intervals in the Y direction. Further, in the present embodiment, a single array in which the plurality of external connection pins 13 are arranged in a line in the Y direction is arranged along a part (side wall) that is located in an end portion of the peripheral wall 11b in the X direction and that extends in the Y direction, and another array in which the plurality of external connection pins 13 are arranged in a line in the Y direction is arranged along a part (side wall) that is located in an end portion of the peripheral wall 11b in a direction opposite to the X direction and that extends in the Y direction. The external connection pins 13 may be made of, for example, a metal material with high conductivity, such as a copper-based metal or an aluminum-based metal. The copper-based metal is copper or a copper alloy, and the aluminum-based metal is aluminum or an aluminum alloy. A conductor of an external wire (not illustrated) is mechanically and electrically connected to each of the external connection pins 13. Further, each of the external connection pins 13 is electrically connected to a conductive wire (not illustrated) of the support member 15A in the housing 11 via a conductor (not illustrated) that is arranged in the feedthrough 14.

The feedthrough 14 includes a conductor and an insulating portion, and penetrates through the peripheral wall 11b of the housing 11. The conductor of the feedthrough 14 may be made of, for example, a metal material with high conductivity, such as a copper-based metal. The conductor of the feedthrough 14 constitutes an external connection conductor together with each of the external connection pins 13 to which the conductor is electrically connected. Further, the insulating portion of the feedthrough 14 may be made of, for example, an insulator, such as ceramics. A boundary between the feedthrough 14 and the housing 11 is hermetically sealed.

The optical devices 12A, a conductor in the cooling mechanism 12C, and the conductor in the feedthrough 14 are electrically connected to one another via bonding wires 18.

A connection substrate 16 is, for example, a flexible printed board, a rigid substrate, or the like. The connection substrate 16 includes an insulating portion (not illustrated) and a plurality of conductive wires (not illustrated). The conductive wires of the connection substrate 16 are electrically connected to the conductor of the feedthrough 14.

The support member 15A supports the optical components 12B. As illustrated in FIG. 1 and FIG. 2, the support member 15A is mounted on the housing 11 in a state of being accommodated in the storage room S. Further, as illustrated in FIG. 2, the support member 15A is mounted on the housing 11 via an adhesive agent 17. Meanwhile, an attaching method is not limited to an adhesive method as long as the support member 15A is fixed to the housing 11. Further, the support member 15A may constitute a part of the housing 11. The housing 11 is one example of a first member and the support member 15A is one example of a second member.

The support member 15A is spread while crossing the Z direction and extends in the X direction and the Y direction. In the storage room S, the support member 15A is arranged on an opposite side of the bottom wall 11a with respect to the plurality of optical devices 12A and portions of the feedthrough 14 in the storage room S. In other words, the support member 15A covers the plurality of optical devices 12A and a part of the feedthrough 14 in the Z direction.

The support member 15A is a plate-shaped member and includes a surface 15a and a surface 15b. The surface 15a is oriented in an opposite direction of the Z direction, is spread while crossing the Z direction, and extends in the X direction and the Y direction. Further, the surface 15b is located at an interval from the surface 15a on the opposite side of the surface 15a in the Z direction. The surface 15b is oriented in the Z direction, is spread while crossing the Z direction, and extends in the X direction and the Y direction. The Z direction is one example of a first direction and may also be referred to as a thickness direction of the support member 15A.

As illustrated in FIG. 1, a plurality of openings 15c1 are arranged in the support member 15A. Further, as illustrated in FIG. 2, the openings 15c1 are through holes that penetrate between the surface 15a and the surface 15b in the Z direction. Meanwhile, it is sufficient that at least the single opening 15c1 is arranged in the support member 15A. The openings 15c1 are one example of through openings, and one example of through holes that penetrate through the support member 15A at positions separated from an edge 15d of the support member 15A in a direction crossing the Z direction.

The optical components 12B are mounted on the support member 15A in a state of penetrating through the openings 15c1, that is, in a state of being partly accommodated in the openings 15c1, via the adhesive agents 17.

As illustrated in FIG. 2, the optical component 12B includes a body 12a and a functional portion 12b. The optical component 12B illustrated in FIG. 2 is, for example, a lens. In this case, the functional portion 12b is a lens portion that transmits light and refracts light. Meanwhile, as another example, when the optical component 12B is a mirror, the functional portion 12b is a mirror portion that reflects light. As still another example, when the optical component 12B is a splitter, the functional portion 12b is a splitter portion that splits light into transmitted light and reflected light. Meanwhile, the optical component 12B may include the plurality of functional portions 12b.

Furthermore, as one example, the body 12a and the functional portion 12b are integrally formed of the same material. In this case, the body 12a and the functional portion 12b may be made of, for example, silicon, a synthetic resin material, an optical glass material, or the like. Moreover, the body 12a and the functional portion 12b may be made of different materials and then integrated, or a first part that includes a part of the body 12a and the functional portion 12b and a second part that includes a different part of the body 12a and that is made of a different material from the first part may be integrated with each other.

The optical component 12B includes a side surface 12c. The side surface 12c includes a portion that faces an inner surface 15e of the opening 15c1 and extends in the Z direction. The side surface 12c may also be referred to as a peripheral surface.

Further, the optical component 12B includes a flange 12d. The flange 12d protrudes in the X direction and the opposite direction of the X direction at a position deviated from the opening 15c1 in the Z direction, in particular, at an end portion of the optical component 12B in the Z direction in the present embodiment. The flange 12d overlaps with a rim of the opening 15c1 in the Z direction. When mounting and positional adjustment of the optical component 12B with respect to the support member 15A are performed in a certain posture in which the Z direction is adopted as a vertically upward direction, it is possible to prevent the optical component 12B from falling from the opening 15c1 by the flange 12d as described above.

The adhesive agent 17 is interposed at least between the flange 12d and the surface 15b of the support member 15A, and bonds the flange 12d and the surface 15b. The adhesive agent 17 is made of a material that includes, for example, epoxy resin. The adhesive agent 17 may have electromagnetic-wave curability, thermosetting property, or moisture curability. Examples of the electromagnetic wave include ultraviolet light. A process of applying the adhesive agent 17 is performed via, for example, a dispenser that supplies the adhesive agent 17 in a fluid state, and a process of curing the adhesive agent 17 is performed via, for example, a nozzle that provides electromagnetic waves, hot air, or moisture.

Here, as is clear from FIG. 2, in the present embodiment, the functional portion 12b of the optical component 12B, the optical device 12A, and the cooling mechanism 12C are located on the opposite side of the surface 15b with respect to the surface 15a of the support member 15A. In contrast, the adhesive agent 17 is located on the opposite side of the surface 15a with respect to the surface 15b and exposed on the opposite side of the surface 15a with respect to the surface 15b. With this configuration, it is possible to more reliably, more smoothly, or more promptly perform the processes of applying and curing the adhesive agent 17 while preventing disturbance by the functional portion 12b of the optical component 12B, the optical device 12A, the cooling mechanism 12C, and the like. Further, layout of the parts 12 is not restricted due to the processes of applying and curing the adhesive agent 17, so that it is possible to improve a degree of freedom of the layout of the parts 12 in the optical apparatus 10A and configure the optical apparatus 10A in a more compact manner, which is an advantage. Meanwhile, the entire adhesive agent 17 need not be located on the opposite side of the surface 15a with respect to the surface 15b, and it is acceptable that at least a part of the adhesive agent 17 is exposed on the opposite side of the surface 15a with respect to the surface 15b and the process of applying or curing the adhesive agent 17 is performed from the opposite side of the surface 15a with respect to the surface 15b.

Furthermore, if only a single portion of the optical component 12B separated from the center of gravity is bonded to the support member 15A, the optical component 12B may be inclined due to a volume change caused by curing or deterioration of the adhesive agent 17. In this regard, in the present embodiment, as illustrated in FIG. 1 and FIG. 2, the adhesive agent 17 is arranged in two portions that are separated from each other in the X direction across the optical component 12B (a center line C that extends in the Z direction while passing through the center of gravity) and that are approximately symmetric to each other with respect to the optical component 12B (the center line C that extends in the Z direction while passing through the center of gravity), so that it is possible to prevent the optical component 12B from being inclined due to a volume change caused by curing or deterioration of the adhesive agent 17.

FIG. 3 is a cross-sectional view of an optical apparatus 10B of a second embodiment that is cut at the same position as illustrated in FIG. 2. The optical apparatus 10B has the same configuration as the optical apparatus 10A of the first embodiment as described above except for a configuration as illustrated in FIG. 3.

As illustrated in FIG. 3, in the present embodiment, a support member 15B supports the optical device 12A in addition to the optical component 12B. The optical device 12A is mounted on the surface 15a.

Further, the support member 15B is configured as a circuit substrate. The support member 15B is, for example, a rigid substrate and a printed wiring board. The support member 15B includes an insulating layer (not illustrated) and a plurality of conductive wires (not illustrated). The insulating layer is made of, for example, an insulating synthetic resin material, such as polyimide. Further, the insulating layer includes a portion that is interposed between the plurality of conductive wires and a portion that covers the conductive wires. The conductive wires have relatively thin band-like shapes. The conductive wires are made of, for example, a metal material with high conductivity, such as a copper-based metal.

The support member 15B is supported by the feedthrough 14. A conductor of the support member 15B and the conductor of the feedthrough 14 are electrically connected to each other via a conductive bonding material 21, such as solder. Further, the optical device 12A and the conductor of the support member 15B are electrically connected to each other via the bonding wires 18.

Even in the present embodiment, it is possible to achieve the same effects as those of the first embodiment as described above. Further, according to the present embodiment, for example, it is possible to simplify the configuration of the optical apparatus 10B as compared to a configuration in which a circuit is arranged separately from the support member 15B and it is possible to easily or more promptly manufacture the optical apparatus 10B because it is possible to incorporate a subassembly in which the optical device 12A is mounted on the support member 15B into the housing 11, which is an advantage.

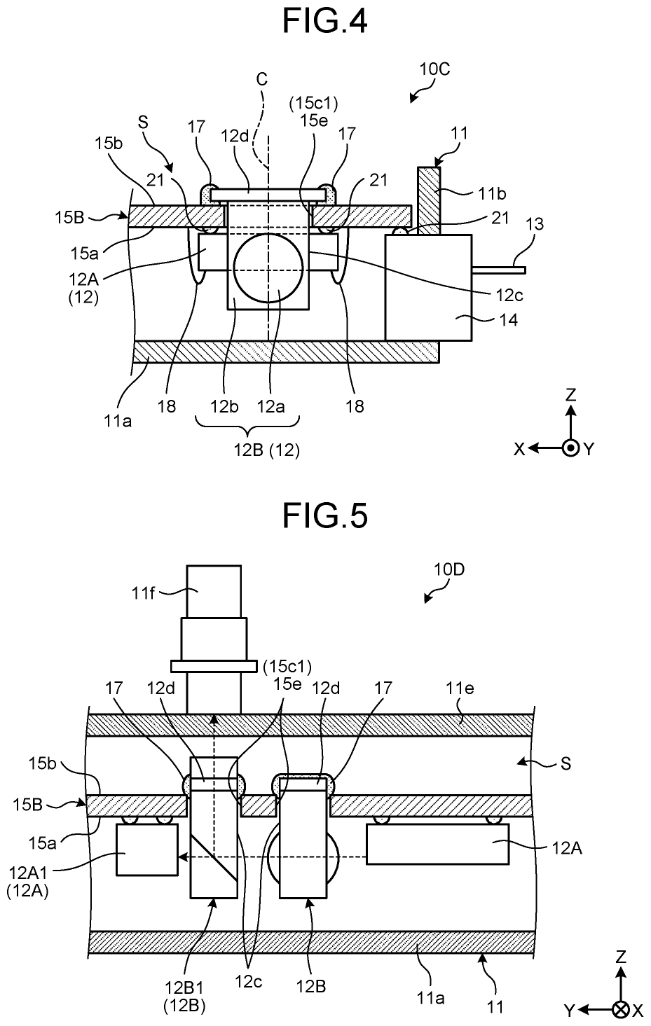

FIG. 4 is a cross-sectional view of an optical apparatus 10C of a third embodiment that is cut at the same position as illustrated in FIG. 2. As illustrated in FIG. 4, in the present embodiment, the optical device 12A is mounted on the surface 15a as flip-chip mounting via the bonding materials 21. The optical apparatus 10C has the same configuration as the optical apparatus 10B of the second embodiment as described above except for the above-described configuration. Even in the present embodiment, it is possible to achieve the same effects as those of the second embodiment as described above.

FIG. 5 is a partial cross-sectional view of an optical apparatus 10D of a fourth embodiment. The optical apparatus 10D has the same configuration as the optical apparatus 10C of the third embodiment as described above except for a configuration as illustrated in FIG. 5.

As illustrated in FIG. 5, in the present embodiment, an optical component 12B1 (12B) is configured as a beam splitter and splits light that travels in the Y direction into light that travels in the Z direction (reflected light) and light that travels in the Y direction (transmitted light).

The light that travels in the Z direction from the optical component 12B1 penetrates through the opening 15c1 through which the optical component 12B1 penetrates, is input to a port 11f that is arranged on a cover 11e of the housing 11, and is output to the outside of the optical apparatus 10D from the port 11f. The port 11f is located on the opposite side of the surface 15a with respect to the surface 15b of the support member 15B.

In contrast, the light that travels in the Y direction from the optical component 12B is input to an optical device 12A1 (12A) that is mounted on the surface 15a. The optical device 12A1 is, for example, a photodiode.

Even in the present embodiment, it is possible to achieve the same effects as those of the third embodiment as described above. Further, according to the present embodiment, for example, it is possible to improve a degree of freedom of layout of the port 11f, so that it is possible to improve a degree of freedom of a light input direction, a light output direction, a light input position, a light output position, or the like with respect to the optical apparatus 10D, which makes it possible to more easily design a system that includes the optical apparatus 10D.

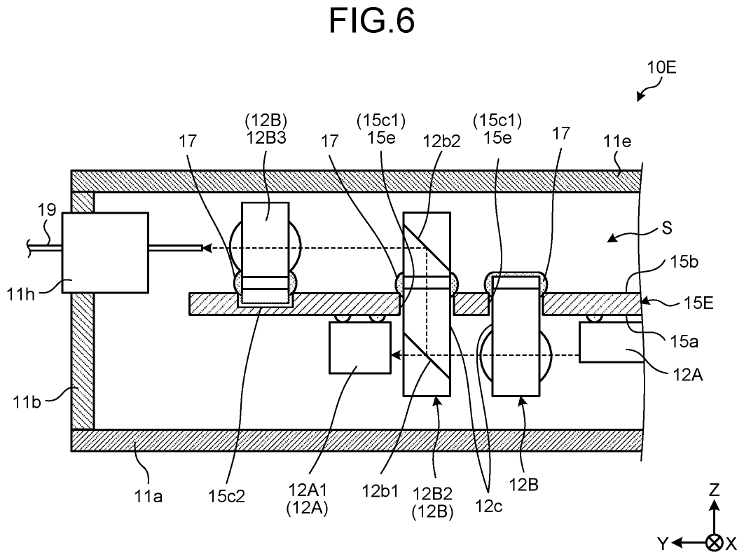

FIG. 6 is a partial cross-sectional view of an optical apparatus 10E of a fifth embodiment. The optical apparatus 10E has the same configuration as the optical apparatus 10C of the third embodiment as described above except for a configuration as illustrated in FIG. 6.

As illustrated in FIG. 6, in the present embodiment, an optical component 12B2 (12B) includes a functional portion 12b1 that serves as a splitter portion for splitting light that travels in the Y direction into light that travels in the Z direction (reflected light) and light that travels in the Y direction (transmitted light), and a functional portion 12b2 that serves as a mirror portion for returning light that travels in the Z direction to the Y direction.

The light that travels in the Y direction (reflected light) from the functional portion 12b2 transmits through an optical component 12B3 (12B), and is input to an optical fiber 19. The optical fiber 19 is supported by a support portion 11h that penetrates through the peripheral wall 11b.

The optical component 12B3 is mounted on a support member 15E via the adhesive agent 17 in a state of being partly accommodated in an opening 15c2. In the present embodiment, the support member 15E includes, as the opening 15c2, a bottomed recess that is opened in the surface 15b.

Even in the present embodiment, it is possible to achieve the same effects as those of the third embodiment as described above. Further, according to the present embodiment, the optical component 12B2 includes the functional portion 12b2 that returns light that has penetrated through the opening 15c1 in the Z direction to the Y direction, so that, for example, it is possible to improve a degree of freedom of a light input direction, a light output direction, a light input position, a light output position, or the like with respect to the optical apparatus 10E, which makes it possible to easily design a system that includes the optical apparatus 10E.

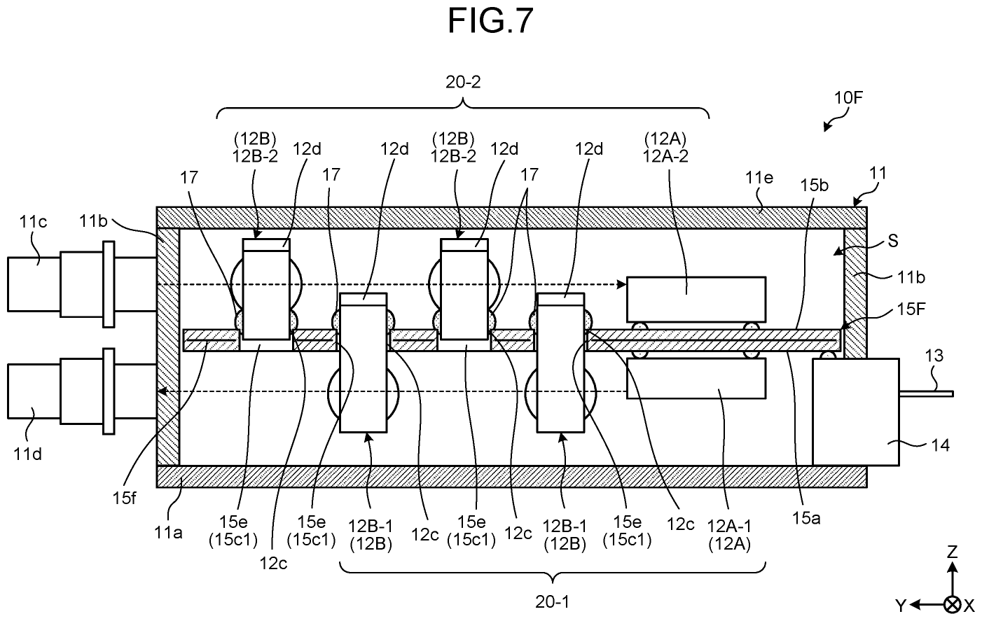

FIG. 7 is a partial cross-sectional view of an optical apparatus 10F of a sixth embodiment. The optical apparatus 10C has the same configuration as the third embodiment as described above except for a configuration as illustrated in FIG. 7.

As illustrated in FIG. 7, in the present embodiment, the optical apparatus 10F includes an optical system 20-1 that is arranged on the surface 15a of a support member 15F as a circuit substrate and a rigid substrate, that is, on the opposite side of the surface 15b with respect to the surface 15a, and an optical system 20-2 that is arranged on the surface 15b of the support member 15F, that is, on the opposite side of the surface 15a with respect to the surface 15b. The optical system 20-1 is one example of a first optical system and the optical system 20-2 is one example of a second optical system. Furthermore, the surface 15a is one example of a first surface and the surface 15b is one example of a second surface.

The optical system 20-1 includes an optical device 12A-1 (12A) that is mounted on the surface 15a, and optical components 12B-1 (12B) in which the functional portions 12b are located on the opposite side of the surface 15b with respect to the surface 15a. Further, the optical system 20-2 includes an optical device 12A-2 (12A) that is mounted on the surface 15b, and optical components 12B-2 (12B) in which the functional portions 12b are located on the opposite side of the surface 15a with respect to the surface 15b. One of the optical systems 20-1 and 20-2 may be configured as an optical system for receiving an optical signal, that is, an optical system to which an optical signal is input, and the other one of the optical systems 20-1 and 20-2 may be configured as an optical system that transmits light of an optical signal or that outputs an optical signal.

The adhesive agents 17 for attaching the optical components 12B to the support member 15F are exposed on the opposite side of the surface 15a with respect to the surface 15b. Therefore, it is possible to perform the processes of applying and curing all of the adhesive agents 17 on the opposite side of the surface 15a with respect to the surface 15b.

The adhesive agents 17 bond the side surfaces 12c of the optical components 12B and the support member 15F. In other words, the adhesive agents 17 are interposed between the optical components 12B and the support member 15F in a direction crossing the side surfaces 12c. Therefore, a volume change caused by curing or deterioration of the adhesive agents 17 occurs in the direction crossing the side surface 12c. If the volume change caused by curing or deterioration of the adhesive agents 17 occurs in a direction extending along the side surfaces 12c, for example in the Z direction, the optical components 12B are easily movable in the Z direction. When optical axis directions (Y direction) of the optical components 12B cross the side surfaces 12c, and if the optical components 12B are deviated in the Z direction, optical paths deviate in the Z direction with respect to the optical axes of the optical components 12B, so that optical performance of the optical apparatus 10F may be degraded. In this regard, in the present embodiment, a volume change caused by curing or deterioration of the adhesive agents 17 occurs in the direction crossing the side surfaces 12c, that is, in the direction crossing the Z direction, so that it is possible to prevent the optical components 12B from moving in the direction extending along the side surfaces 12c, that is, in the Z direction. With this configuration, in the configuration in which the optical axis directions (Y direction) of the optical components 12B and the side surface 12c cross each other, it is possible to prevent degradation of the optical performance of the optical apparatus 10F due to a volume change caused by curing or deterioration of the adhesive agents 17.

Furthermore, each of the optical components 12B includes the flange 12d. The flange 12d overlaps with the rims of the openings 15c1 in the Z direction. Therefore, when mounting and positional adjustment of the optical components 12B with respect to the support member 15F are performed in a certain posture in which the Z direction is adopted as a vertically upward direction, it is possible to prevent the optical components 12B from falling from the openings 15c1 by the flange 12d as described above.

The support member 15F includes a conductor layer 15f that extends while crossing the thickness direction (Z direction). The conductor layer 15f functions as an electromagnetic shield and is able to block propagation of unneeded electromagnetic waves between the optical system 20-1 and the optical system 20-2 and prevent electromagnetic crosstalk.

Furthermore, the support member 15F is able to block unneeded light (stray light) and prevent optical crosstalk between the optical system 20-1 and the optical system 20-2.

Even in the present embodiment, it is possible to achieve the same effects as those of the third embodiment as described above. Further, according to the present embodiment, for example, it is possible to arrange the two optical systems 20-1 and 20-2 side by side in the Z direction, so that it is possible to configure the optical apparatus 10F in a more compact manner in the X direction as compared to an optical apparatus in which the optical apparatus 10F including the two optical systems 20-1 and 20-2 is arranged in a direction crossing the Z direction, for example, in the X direction.

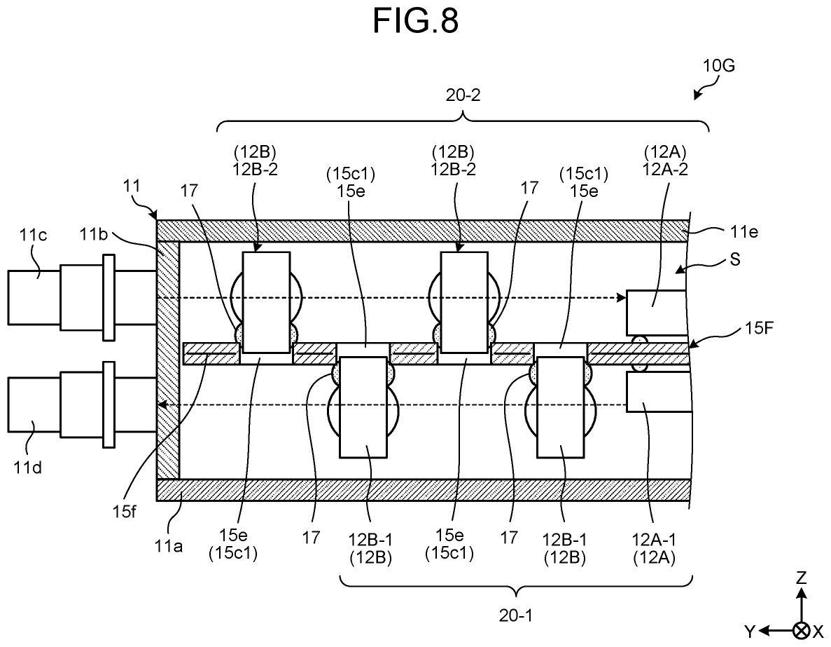

FIG. 8 is a partial cross-sectional view of an optical apparatus 10G of a seventh embodiment. The optical apparatus 10F has the same configuration as the sixth embodiment as described above except for a configuration as illustrated in FIG. 8.

As illustrated in FIG. 8, in the present embodiment, the adhesive agent 17 for attaching the optical components 12B of the optical system 20-1 to the support member 15F is exposed on the opposite side of the surface 15b with respect to the surface 15a, and the adhesive agent 17 for attaching the optical components 12B of the optical system 20-2 to the support member 15F is exposed on the opposite side of the surface 15a with respect to the surface 15b. In this case, for example, it is sufficient to configure the optical system 20-1 by mounting the optical components 12B and the optical devices 12A on the surface 15a of the support member 15F and thereafter configure the optical system 20-2 by mounting the optical components 12B and the optical devices 12A on the surface 15b on the opposite side of the optical system 20-1.

Even in the present embodiment, it is possible to achieve the same effects as those of the sixth embodiment as described above.

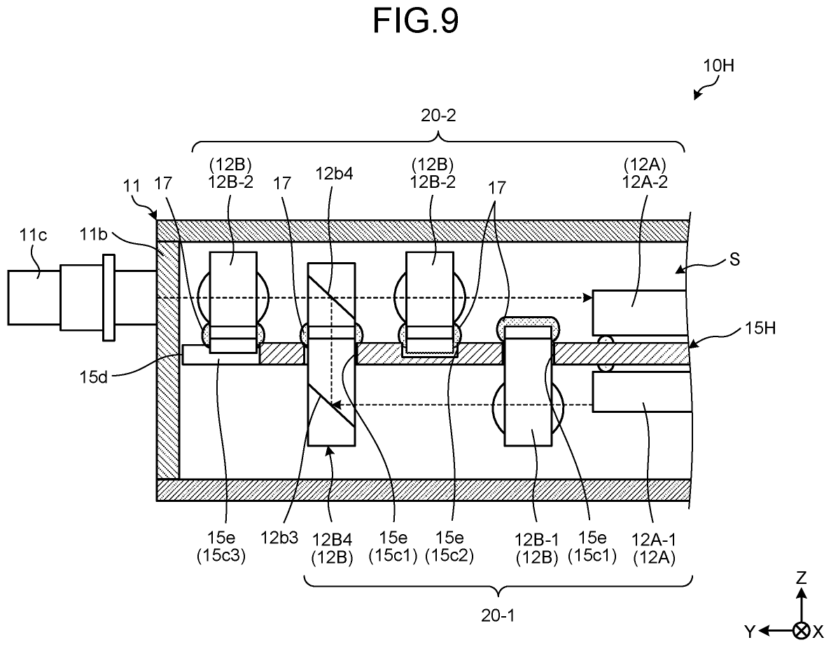

FIG. 9 is a partial cross-sectional view of an optical apparatus 10H of an eighth embodiment. The optical apparatus 10H has the same configuration as the optical apparatus 10G of the seventh embodiment as described above, except for a configuration as illustrated in FIG. 9.

As illustrated in FIG. 9, in the present embodiment, an optical component 12B4 (12B) includes a functional portion 12b3 that serves as a mirror portion for reflecting light that travels in the Y direction to the Z direction and a functional portion 12b4 that serves as a filter portion for reflecting light that travels in the Z direction (reflected light) from the functional portion 12b3 to the Y direction and transmitting light that travels in an opposite direction of the Y direction. As one example, the functional portion 12b4 is configured as a wavelength multiplexing filter or a wavelength division multiplexing filter, and is able to reflect light at a wavelength in a first wavelength band and transmit light at a wavelength in a second wavelength band that is different from the first wavelength band. Further, as a different example, the functional portion 12b4 may be configured as a polarization beam combiner (splitter) and is able to switch between reflection and transmission of light depending on a polarization direction. In this case, the optical system 20-1 may be configured as an optical system that transmits or outputs an optical signal, and the optical system 20-2 may be configured as an optical system that receives the optical signal, that is, an optical system to which the optical signal is input. The light that is transmitted between the optical system 20-1 and the optical system 20-2 penetrates through the opening 15c1 in which the optical component 12B4 is partly accommodated, and transmits through the optical component 12B4. With this configuration, it is possible to share the functional portion 12b4 of the optical component 12B4, the optical components 12B, and a port 11g for receiving light of the optical signal and transmitting light of the optical signal.

Furthermore, an opening 15c3 that is located in the vicinity of the edge 15d of a support member 15H and that accommodates a part of the optical component 12B is configured as a notch by cutting the edge 15d. The opening 15c3 is recessed from the edge 15d in the opposite direction of the Y direction and penetrates through the support member 15H in the Z direction. In this manner, when the optical component 12B is located in the vicinity of the edge 15d, the opening 15c3 may be configured as a notch.

Even in the present embodiment, it is possible to achieve the same effects as those of the seventh embodiment as described above. Further, according to the present embodiment, for example, the optical components 12B are shared, so that it is possible to reduce the number of components, reduce manufacturing loads and costs of the optical apparatus 10H, and configure the optical apparatus 10H in a more compact manner, which is an advantage.

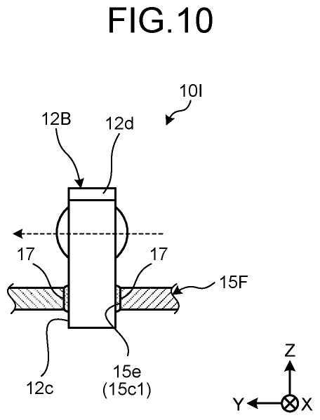

FIG. 10 is a partial cross-sectional view of an optical apparatus 10I of a tenth embodiment. The optical apparatus 10I has the same configuration as the optical apparatus 10F of the sixth embodiment as described above except for a configuration as illustrated in FIG. 10.

As illustrated in FIG. 10, in the present embodiment, the adhesive agent 17 is interposed between the side surface 12c of the optical component 12B and an inner surface 15e of the opening 15c1 over the entire circumference of the optical component 12B. Even in the present embodiment, it is possible to achieve the same effects as those of the sixth embodiment as described above. Meanwhile, the adhesive agent 17 need not be continuously arranged over the entire circumference, but may be arranged in a plurality of portions at intervals in a circumferential direction around the side surface 12c of the optical component 12B. In this case, the adhesive agent 17 may include at least a single combination of two portions that sandwich the optical component 12B, or may include a combination of two portions that sandwich the optical component 12B in the X direction and a combination of two portions that sandwich the optical component 12B in the Y direction.

According to one aspect of the present disclosure, it is possible to achieve an optical apparatus that includes an improved and novel component that may easily prevent inconvenience related to an adhesive agent.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical apparatus comprising:
a housing including a first member constituting at least a part of the housing;
an optical component accommodated in the housing and configured to transmit or reflect light; and
a second member fixed to the first member and including at least one opening configured to accommodate a part of the optical component, the second member being configured to support the optical component via an adhesive agent.

2. The optical apparatus according to claim 1, further comprising an optical device accommodated in the housing and configured to perform at least one of reception of light, transmission of light, and change of optical properties.

3. The optical apparatus according to claim 2, wherein the optical device is supported by the second member.

4. The optical apparatus according to claim 1, wherein
the optical component includes a side surface that includes a portion facing an inner surface of the opening, and
the adhesive agent bonds the side surface and the second member.

5. The optical apparatus according to claim 1, wherein the adhesive agent is arranged at positions approximately symmetric to each other with respect to the optical component.

6. The optical apparatus according to claim 1, wherein the opening of the second member is a through opening configured to penetrate through the second member in a first direction.

7. The optical apparatus according to claim 6, wherein the through opening of the second member is a through hole that is separated from an edge of the second member in a second direction that crosses the first direction.

8. The optical apparatus according to claim 6, wherein the through opening of the second member is a notch formed by cutting an edge of the second member in a second direction that crosses the first direction.

9. The optical apparatus according to claim 6, wherein the optical component includes a flange at a position deviated from the opening in the first direction such that the flange overlaps with a rim of the opening in the first direction.

10. The optical apparatus according to claim 9, wherein the adhesive agent bonds the second member and the flange.

11. The optical apparatus according to claim 6, wherein
the second member includes a first surface located on one end in the first direction and a second surface located on another end in the first direction,
the optical component includes an optical element configured to transmit or reflect light on an opposite side of the second surface with respect to the first surface, the optical element being supported by the second member via the adhesive agent that is exposed on an opposite side of the first surface with respect to the second surface.

12. The optical apparatus according to claim 6, wherein the opening is configured such that the light penetrates through the opening in the first direction.

13. The optical apparatus according to claim 6, wherein the optical component includes an optical element configured to direct light penetrated through the opening in the first direction to a second direction that crosses the first direction.

14. The optical apparatus according to claim 1, wherein the opening of the second member is a bottomed recess.

15. The optical apparatus according to claim 1, wherein
the second member includes a first surface and a second surface that is located on an opposite side of the first surface,
the optical component includes:
a first optical system including a first optical element arranged on an opposite side of the second surface with respect to the first surface; and
a second optical system including a second optical element arranged on an opposite side of the first surface with respect to the second surface.

16. The optical apparatus according to claim 15, wherein
the opening of the second member is a through opening configured to penetrate through the second member in the first direction,
the first surface and the second surface are separated from each other in the first direction, and
light is transmitted between the first optical system and the second optical system via the through opening.

17. The optical apparatus according to claim 1, further comprising
an electrical component accommodated in the housing, wherein
the second member is a circuit substrate including
a conductor configured to electrically connect the electrical component and an external apparatus, and
an insulator.

18. The optical apparatus according to claim 17, wherein the conductor of the second member is a conductor layer that extends while crossing a thickness direction of the circuit substrate.

19. An optical apparatus comprising:
a housing including a first member constituting at least a part of the housing;
an optical component accommodated in the housing and configured to transmit or reflect light; and
a second member fixed to the first member and configured to support the optical component, the second member including a first surface and a second surface that is located on an opposite side of the first surface,
wherein the optical component includes
a first optical system including a first optical element arranged on an opposite side of the second surface with respect to the first surface, and
a second optical system including a second optical element arranged on an opposite side of the first surface with respect to the second surface.
